(19) United States
(12) Patent Application Publication
(10) Pub. No.: US 2020/0301840 A1
(43) Pub. Date: Sep. 24, 2020

(54) PREFETCH APPARATUS AND METHOD USING CONFIDENCE METRIC FOR PROCESSOR CACHE

(71) Applicant: Shanghai Zhaoxin Semiconductor Co., Ltd., Shanghai (CN)

(72) Inventors: Douglas Raye Reed, Austin, TX (US); Akarsh Dolthatta Hebbar, Austin, TX (US)

(21) Appl. No.: 16/358,792

(22) Filed: Mar. 20, 2019

(51) Int. Cl. G06F 12/0862

(52) U.S. Cl. CPC G06F 12/0862; G06F 2212/602

(57) ABSTRACT

Methods and apparatus are provided to implement a unique quasi least recently used (LRU) implementation of an n-way set-associative cache. In accordance with one implementation, a method determines to generate a prefetch request, obtains a confidence value for target data associated with the prefetch request, writes the target data into a set of the n-way set associative cache memory, modifies an n-position array of the cache memory, such that a particular one of n array positions identifies one of the n ways, wherein the particular one of the n LRU array positions is determined by the confidence value.

### TECHNICAL FIELD

The present invention relates in general to cache memory circuits, and more particularly, to systems and methods for prefetching data into a processor cache.

### BACKGROUND

Most modern computer systems include a microprocessor that performs the computations necessary to execute software programs. Computer systems also include other devices connected to (or internal to) the microprocessor, such as memory. The memory stores the software program instructions to be executed by the microprocessor. The memory also stores data that the program instructions manipulate to achieve the desired function of the program.

The devices in the computer system that are external to the microprocessor (or external to a processor core), such as the memory, are directly or indirectly connected to the microprocessor (or core) by a processor bus. The processor bus is a collection of signals that enable the microprocessor to transfer data in relatively large chunks. When the microprocessor executes program instructions that perform computations on the data stored in the memory, the microprocessor must fetch the data from memory into the microprocessor using the processor bus. Similarly, the microprocessor writes results of the computations back to the memory using the processor bus.

The time required to fetch data from memory or to write data to memory is many times greater than the time required by the microprocessor to perform the computation on the data. Consequently, the microprocessor must inefficiently wait idle for the data to be fetched from memory. To reduce this problem, modern microprocessors include at least one cache memory. The cache memory, or cache, is a memory internal to the microprocessor (or processor core)—typically much smaller than the system memory—that stores a subset of the data in the system memory. When the microprocessor executes an instruction that references data, the microprocessor first checks to see if the data is present in the cache and is valid. If so, the instruction can be executed more quickly than if the data had to be retrieved from system memory since the data is already present in the cache. That is, the microprocessor does not have to wait while the data is fetched from the memory into the cache using the processor bus. The condition where the microprocessor detects that the data is present in the cache and valid is commonly referred to as a cache hit. The condition where the referenced data is not present in the cache is commonly referred to as a cache miss. When the referenced data is already in the cache memory, significant time savings are realized, by avoiding the extra clock cycles required to retrieve data from external memory.

Cache prefetching is a technique used by computer processors to further boost execution performance by fetching instructions or data from external memory into a cache memory, before the data or instructions are actually needed by the processor. Successfully prefetching data avoids the latency that is encountered when having to retrieve data from external memory.

There is a basic tradeoff in prefetching. As noted above, prefetching can improve performance by reducing latency (by already fetching the data into the cache memory, before it is actually needed). On the other hand, if too much information (e.g., too many cache lines) is prefetched, then the efficiency of the prefetcher will be reduced, and other system resources and bandwidth may be overtaxed. Furthermore, if a cache is full, then prefetching a new cache line into that cache will result in eviction from the cache of another cache line. Thus, a line in the cache that was in the cache because it was previously needed might be evicted by a line that only might be needed in the future.

In some microprocessors, the cache is actually made up of multiple caches. The multiple caches are arranged in a hierarchy of multiple levels. For example, a microprocessor may have two caches, referred to as a first-level (L1) cache and a second-level (L2) cache. The L1 cache is closer to the computation elements of the microprocessor than the L2 cache. That is, the L1 cache is capable of providing data to the computation elements faster than the L2 cache. The L2 cache is commonly larger than the L1 cache, although not necessarily.

One effect of a multi-level cache arrangement upon a prefetch instruction is that the cache line specified by the prefetch instruction may hit in the L2 cache but not in the L1 cache. In this situation, the microprocessor can transfer the cache line from the L2 cache to the L1 cache instead of fetching the line from memory using the processor bus since the transfer from the L2 to the L1 is much faster than fetching the cache line over the processor bus. That is, the L1 cache allocates a cache line, i.e., a storage location for a cache line, and the L2 cache provides the cache line to the L1 cache for storage therein.

While prefetchers are known, there is a desire to improve the performance of prefetchers.

### SUMMARY

In accordance with one embodiment, a cache memory comprises a memory area for storing data requested by the cache memory, the memory area being configured with n-way set associativity; prefetch logic configured to execute an algorithm for assessing whether target data external to the cache memory will be requested by the cache memory in the near future; an array of storage locations generally organized in the form of k (where k is an integer value greater than 1) one-dimensional arrays, each of the k arrays having n locations, wherein each such array location identifies a unique one of the n-ways of the memory area for a given one of the k arrays, and wherein each array is organized such that a sequential order of the plurality of array locations generally identifies the n-ways in the order that they are to be replaced; further comprising, for each of the plurality of one-dimensional arrays: confidence logic associated with the prefetch logic configured to compute a confidence measure, which confidence measure reflects a determined likelihood that the target data will be requested by an associated processor in the near future; and control logic configured to manage the contents of data in each array location, the control logic being further configured to: assign a particular one the array locations to correspond to the way where the target data is to be stored, based on the computed confidence measure; shift a value in each array location, from the assigned array location toward an array location corresponding to a position for next replacement; and write a value previously held in the array location corresponding to a next replacement position into the assigned array location. In accordance with another embodiment, An n-way set associative cache memory comprises: prefetch logic configured to execute an algorithm for assessing whether target data external to the cache memory will be requested by the cache memory in the near future; a k-set array, each of the k sets having n array locations, wherein each of the n array locations identifies a unique one of the n-ways of a given set of the cache memory; confidence logic configured to compute a confidence measure that reflects a determined likelihood that the target data will be requested by an associated processor in the near future; and control logic configured to adjust the values in a select one of the k sets by writing a value from the array location corresponding to a least recently used (LRU) position to an intermediate location in the selected set, based on confidence measure, and shifting values in each array location from that intermediate storage toward the penultimate LRU position by one location.

In accordance with yet another embodiment, a method is implemented in an n-way set associative cache memory, the method comprises: determining to generate a prefetch request; obtaining a confidence value for target data associated with the prefetch request; writing the target data into a set of the n-way set associative cache memory; modifying an n-position array of the cache memory, such that a particular one of n array positions identifies one of the n ways, wherein the particular one of the n LRU array positions is determined by the confidence value.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Various aspects of the disclosure can be better understood with reference to the following drawings. The components in the drawings are not necessarily to scale, with emphasis instead being placed upon clearly illustrating the principles of the present disclosure. Moreover, in the drawings, like reference numerals designate corresponding parts throughout the several views.

FIG. 1 is a block diagram showing certain features of a processor implementing the present invention;

FIG. 2 is a block diagram showing certain features of a cache memory, primarily utilized for communications with other system components;

FIG. 3 is a block diagram of a cache memory, showing principal features of an embodiment of the invention;

FIGS. 4A-4D are diagrams of one set of an LRU array, illustrating the sequencing of contents of the set of a conventional LRU array in a hypothetical example;

FIG. 5 is a flowchart showing an example algorithm for generating a confidence value of a prefetch operation;

FIGS. 6A-6B are diagrams showing an array of one set generally organized as an LRU array and illustrating the sequencing of contents of the array in accordance with a preferred embodiment of the invention; and

FIG. 7 is a flowchart showing basic operations in a prefetch operation, in accordance with an embodiment of the invention.

FIG. 8A-8B illustrate a binary tree and a table reflecting the implementation of the invention in the utilizing a pseudo LRU implementation

### DETAILED DESCRIPTION

While the invention is susceptible to various modifications and alternative forms, specific embodiments thereof are shown by way of example in the drawings and will herein be described in detail sufficient for an understanding of persons skilled in the art. It should be understood, however, that the drawings and detailed description thereto are not intended to limit the invention to the particular form disclosed. On the contrary, the intention is to cover all modifications, equivalents and alternatives falling within the spirit and scope of the present invention as defined by the appended claims. The headings used herein are for organizational purposes only and are not meant to be used to limit the scope of the description. As used throughout this application, the word “may” is used in a permissive sense (i.e., meaning having the potential to), rather than the mandatory sense (i.e., meaning must). Similarly, the words “include”, “including”, and “includes” mean including, but not limited to.

Various units, modules, circuits, logic, or other components may be described as “configured to” perform a task or tasks. In such contexts, “configured to” is a broad recitation of structure generally meaning “having circuitry or another physical structure that” performs, or is capable of performing, the task or tasks during operation. The circuitry may be dedicated circuitry, or more general processing circuitry operating under the control of coded instructions. That is, terms like “unit”, “module”, “circuit”, “logic”, and “component” may be used herein, in describing certain aspects or features of various implementations of the invention. It will be understood by persons skilled in the art that the corresponding features are implemented utilizing circuitry, whether it be dedicated circuitry or more general purpose circuitry operating under micro-coded instruction control.

Further, the unit/module/circuit/logic/component can be configured to perform the task even when the unit/module/circuit/logic/component is not currently in operation. Reciting a unit/module/circuit/logic/component that is configured to perform one or more tasks is expressly intended not to invoke 35 U.S.C. § 112(f) for that unit/module/circuit/logic/component. In this regard, persons skilled in the art will appreciate that the specific structure or interconnections of the circuit elements will typically be determined by a compiler of a design automation tool, such as a register transfer language (RTL) compiler. RTL compilers operate upon scripts that closely resemble assembly language code, to compile the script into a form that is used for the layout or fabrication of the ultimate circuitry.

That is, integrated circuits (such as those of the present invention) are designed using higher-level software tools to model the desired functional operation of a circuit. As is well known, “Electronic Design Automation” (or EDA) is a category of software tools for designing electronic systems, such as integrated circuits. EDA tools are also used for programming design functionality into field-programmable gate arrays (FPGAs). Hardware descriptor languages (HDLs), like Verilog and very high-speed integrated circuit (VHDL) are used to create high-level representations of a circuit, from which lower-level representations and ultimately actual wiring can be derived. Indeed, since a modern semiconductor chip can have billions of components, EDA tools are recognized as essential for their design. In practice, a circuit designer specifies operational functions using a programming language like C/C++. An EDA software tool converts that specified functionality into RTL. Then, a hardware descriptor language (e.g. Verilog) converts the RTL into a discrete netlist of gates. This netlist defines the actual circuit that is produced by, for example, a foundry. Indeed, these tools are well known and understood for their role and use in the facilitation of the design process of electronic and digital systems, and therefore need not be described herein.

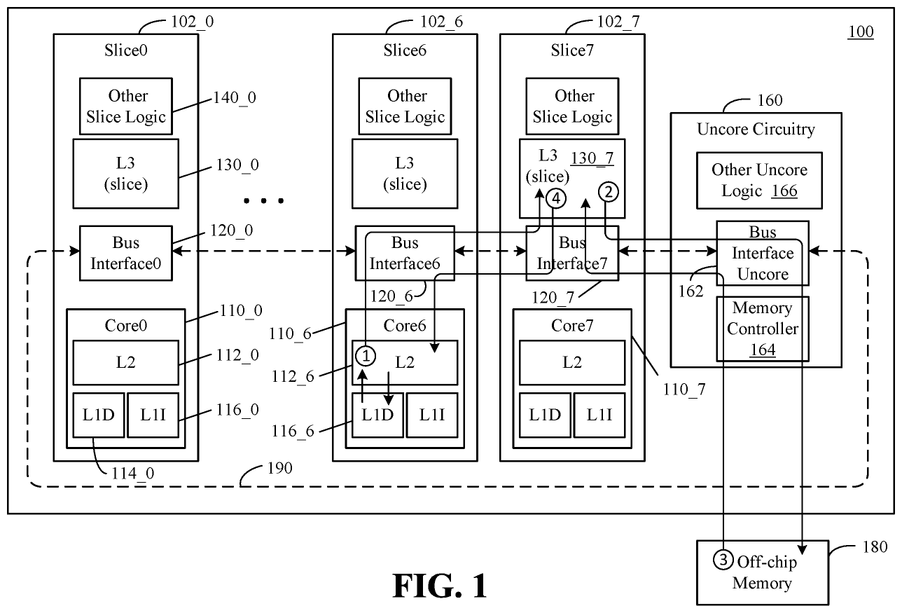

As will be described herein, the present invention is directed to an improved mechanism for prefetching data into a cache memory. Before describing this prefetching mechanism, however, one exemplary architecture is described, in which the inventive prefetcher may be utilized. In this regard, reference is now made to FIG. 1, which is a diagram illustrating a multi-core processor 100. As will be appreciated by persons having ordinary skill in the art from the description provided herein, the present invention may be implemented in a variety of various circuit configurations and architectures, and the architecture illustrated in FIG. 1 is merely one of many suitable architectures. Specifically, in the embodiment illustrated in FIG. 1, the processor 100 is an eight-core processor, wherein the cores are enumerated core0 110_0 through core7 110_7.

In the illustrated embodiment, numerous circuit components and details are omitted, which are not germane to an understanding of the present invention. As will be appreciated by persons skilled in the art, each processing core (110_0 through 110_7), includes certain associated or companion circuitry that is replicated throughout the processor 100. Each such related sub-circuit is denoted in the illustrated embodiment as a slice. With eight processing cores 110_0 through 110_7, there are correspondingly eight slices 102_0 through 102_7. Other circuitry that is not described herein is merely denoted as “other slice logic” 140_0 through 140_7.

In the illustrated embodiment, a three-level cache system is employed, which includes a level one (L1) cache, a level two (L2) cache, and a level three (L3) cache. The L1 cache is separated into both a data cache and an instruction cache, respectively denoted as L1D and L1I. The L2 cache also resides on core, meaning that both the level one cache and the level two cache are in the same circuitry as the core of each slice. That is, each core of each slice has its own dedicated L1D, L1I, and L2 caches. Outside of the core, but within each slice is an L3 cache. In the preferred embodiment, the L3 cache 130_0 through 130_7 (also collectively referred to herein as 130) is a distributed cache, meaning that ⅛ of the L3 cache resides in slice 0 102_0, ⅛ of the L3 cache resides in slice 1 102_1, etc. In the preferred embodiment, each L1 cache is 32 k in size, each L2 cache is 256 k in size, and each slice of the L3 cache is 2 megabytes in size. Thus, the total size of the L3 cache is 16 megabytes.

Bus interface logic 120_0 through 120_7 is provided in each slice in order to manage communications from the various circuit components among the different slices. As illustrated in FIG. 1, a communication bus is 190 is utilized to allow communications among the various circuit slices, as well as with uncore circuitry 160. The uncore circuitry merely denotes additional circuity that is on the processor chip, but is not part of the core circuitry associated with each slice. As with each illustrated slice, the un-core circuitry 160 includes a bus interface circuit 162. Also illustrated is a memory controller 164 for interfacing with off-processor memory 180. Finally, other un-core logic 166 is broadly denoted by a block, which represents other circuitry that may be included as a part of the un-core processor circuitry (and again, which need not be described for an understanding of the invention).

To better illustrate certain inter and intra communications of some of the circuit components, the following example will be presented. This example illustrates communications associated with a hypothetical load miss in core6 cache. That is, this hypothetical assumes that the processing core 6 110_6 is executing code that requests a load for data at address hypothetical address 1000. When such a load request is encountered, the system first performs a lookup in L1D 114_6 to see if that data exists in the L1D cache. Assuming that the data is not in the L1D cache, then a lookup is performed in the L2 cache 112_6. Again, assuming that the data is not in the L2 cache, then a lookup is performed to see if the data exists in the L3 cache. As mentioned above, the L3 cache is a distributed cache, so the system first needs to determine which slice of the L3 cache the data should reside in, if in fact it resides in the L3 cache. As is known, this process can be performed using a hashing function, which is merely the exclusive ORing of bits, to get a three bit address (sufficient to identify which slice—slice 0 through slice 7—the data would be stored in).

In keeping with the example, assume this hashing function results in an indication that the data, if present in the L3 cache, would be present in that portion of the L3 cache residing in slice 7. A communication is then made from the L2 cache of slice 6 102_6 through bus interfaces 120_6 and 120_7 to the L3 slice present in slice 7 102_7. This communication is denoted in the figure by the number 1. If the data was present in the L3 cache, then it would be communicated back from L3 130_7 to the L2 cache 112_6. However, and in this example, assume that the data is not in the L3 cache either, resulting in a cache miss. Consequently, a communication is made from the L3 cache 130_7 through bus interface 7 120_7 through the un-core bus interface 161 to the off-chip memory 180, through the memory controller 164. A cache line that includes the data residing at address 1000 is then communicated from the off-chip memory 180 back through memory controller 164 and un-core bus interface 162 into the L3 cache 130_7. After that data is written into the L3 cache, it is then communicated to the requesting core, core 6 110_6 through the bus interfaces 120_7 and 120_6. Again, these communications are illustrated by the arrows numbered 1, 2, 3, and 4 in the diagram.

At this point, once the load request has been completed, that data will reside in each of the caches L3, L2, and L1D. The present invention is directed to an improved prefetcher that preferable resides in each of the L2 caches 112_0 through 112_7. It should be understood, however, that consistent with the scope and spirit of the present invention, the inventive prefetcher could be incorporated in each of the different level caches, should system architecture and design constraints merit. In the illustrated embodiment, however, as mentioned above, the L1 cache is relatively small sized cache. Consequently, there can be performance and bandwidth consequences for prefetching too aggressively in the L1 cache level. In this regard, a more complex or aggressive prefetcher generally consumes more silicon real estate in the chip, as well as more power and other resources. Also, from the example described above, excessive prefetching into the L1 cache would often result in more misses and evictions. This would consume additional circuit resources, as well as bandwidth resources for the communications necessary for prefetching the data into the respective L1 cache. More specifically, since the illustrated embodiment shares an on-chip communication bus denoted by the dashed line 190, excessive communications would consume additional bandwidth, potentially unnecessarily delaying other communications or resources that are needed by other portions of the processor 100.

In the preferred embodiment the L1I and L1D caches are both smaller than the L2 and need to be able to satisfy data requests much faster. Therefore the prefetcher that is implemented in the L1I and L1D caches of each slice, is preferably a relatively simple prefetcher. As well, the L1D cache needs to be able to pipeline requests. Therefore, putting additional prefetching circuitry in the L1D can be relatively taxing. Further still, a complicated prefetcher would likely get in the way of other necessary circuitry. With regard to the cache line of each of the L1 caches, in the preferred embodiment the cache line is 64 bytes. Thus, 64 bytes of load data can be loaded per clock cycle.

As mentioned above, the L2 prefetcher is preferably 256 KB in size. Having a larger data area, the prefetcher implemented in the L2 cache can be more complex and aggressive. Generally, implementing a more complicated prefetcher in the L2 cache results in less of a performance penalty for bringing in data speculatively. Therefore, in the preferred architecture, the prefetcher of the present invention is implemented in the L2 cache.

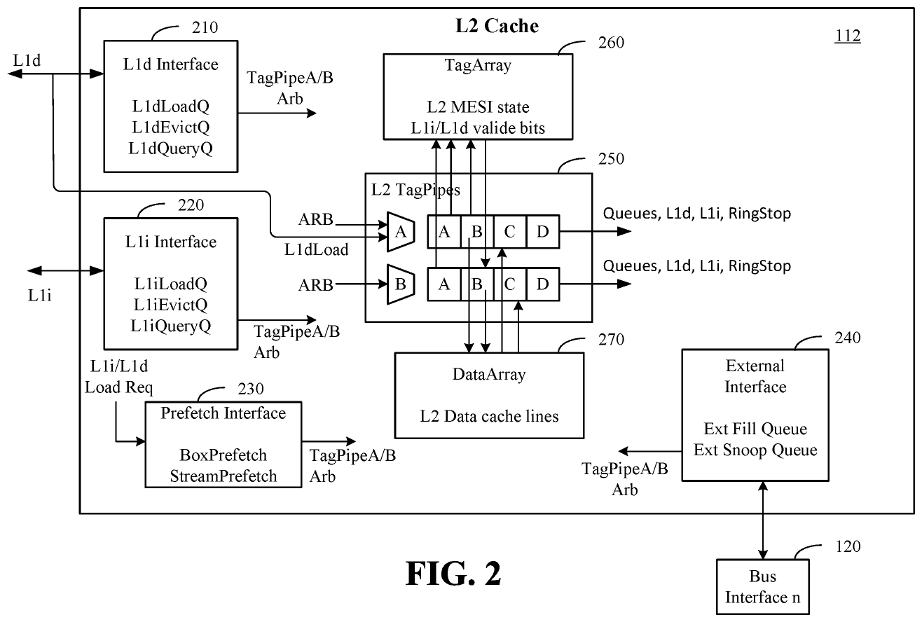

Before describing details of the inventive prefetcher, reference is first made to FIG. 2, which is a block diagram illustrating various circuit components of each of the L2 caches. Specifically, the components illustrated in FIG. 2 depict basic features a structure that facilitates the communications within the L2 cache and with other components in the system illustrated in FIG. 1. First, there are four boxes 210, 220, 230, and 240, which illustrate an L1D interface 210, an L1I interface 220, a prefetch interface 230, and an external interface 240. Collectively, these boxes denote circuitry that queue and track transactions or requests through the L2 cache 112. As illustrated in FIG. 1, in each core, there is both L1D and L1I cache, and a higher level L2 cache. The L1D interface 210 and L1I interface 220 interface the L2 cache with the L1 caches. These interfaces implement a load queue, an evict queue and a query queue, for example, as mechanisms to facilitate this communication. The prefetch interface 230 is circuitry that facilitates communications associated with the prefetcher of the present invention, which will be described in more detail below. In a preferred embodiment, the prefetcher implements both a bounding box prefetch algorithm and a stream prefetch algorithm, and ultimately makes a prefetch determination as a result of the combination of the results of those two algorithms. The bounding box prefetch algorithm may be similar to that described in U.S. Pat. No. 8,880,807, which is incorporated herein by reference. There are numerous, known stream prefetching algorithms, which may be utilized by the invention, and the invention is not limited to any particularly prefetching algorithm.

As will be appreciated by those skilled in the art, the prefetching algorithms are performed in part by monitoring load requests from respective core to the associated L1I and L1D caches. Accordingly, these are illustrated as inputs to the prefetch interface 230. The output of the prefetch interface 230 is in the form of an arbitration request of tagpipe 250, whose relevant function, which briefly described herein, will be appreciated by persons skilled in the art. Finally, the external interface 240 provides the interface to components outside the L2 cache and indeed outside the processor core. As described in connection with FIG. 1, such communications, particularly off-slice communications, are routed through bus interface 120.

As illustrated in FIG. 2, each of the circuit blocks 210, 220, 230, and 240, have outputs that are denoted as tagpipe arbitration (arb) requests. Tagpipes 250 are provided as a central point through which almost all L2 cache traffic travels. In the illustrated embodiment, there are two tagpipes denoted as A and B. Two such tagpipes are provided merely for load balancing, and as such the tagpipe request that are output from circuits 210, 220, 230, and 240, the various interface circuits, can be directed to either tagpipe A or tagpipe B, again based on load balancing. In the preferred embodiment, the tagpipes are four stage pipes, with the stages denoted by letters A, B, C, and D. Transactions to access the cache, sometimes referred to herein as “tagpipe arbs,” advance through the stages of the tagpipe 250. During the A stage, a transaction arbitrates into the tagpipe. During the B stage, the tag is sent to the arrays (tag array 260 and data array 270). During the C stage, MESI information and indication of whether the tag hit or miss in the LLC is received from the arrays and a determination is made on what action to take in view of the information received from the array. During the D stage, the action decision (complete/replay, push a fillq, etc) is staged back to the requesting queues.

Finally, FIG. 2 illustrates a tag array 260 and data array 270. The tag array 260 effectively or essentially includes metadata while the data array is the memory space that includes the actual cache lines of data. The metadata in the tag array 260 includes MESI state as well as the L1I and L1D valid bits. As is known, the MESI state defines whether the data stored in the data array are in one of the modified (“M”), exclusive (“E”), shared (“S”), or invalid (“I”) states.

A similar, but previous, version of this architecture is described in U.S. 2016/0350215, which is hereby incorporated by reference. As an understanding of the specifics with respect to the intra-circuit component communication is not necessary for an understanding of the present invention, and indeed is within the level of skill of persons of ordinary skill in the art, it need not be described any further herein.

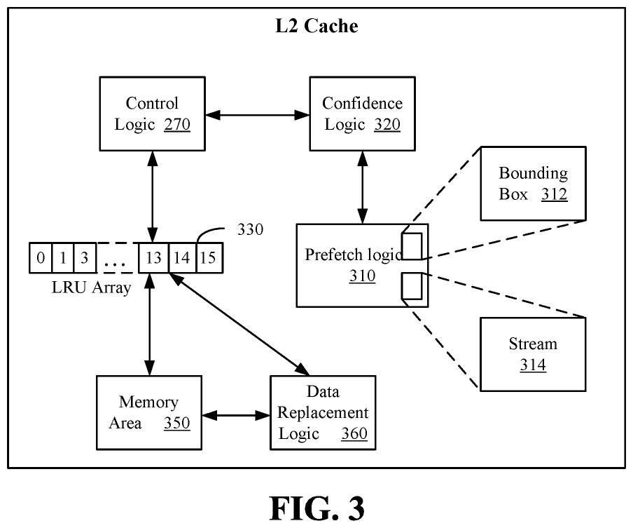

Reference is now made to FIG. 3, which is a diagram illustrating certain functional components associated with the prefetcher in the L2 cache 112. As described above, while the blocks in this diagram denote functional units, it will be appreciated that each of these units is implemented through circuitry, whether that be dedicated circuitry, or more general purpose circuitry operating under microcoded instruction control. In this regard, prefetcher 310 is configured to perform a prefetching algorithm to assess whether and which data to prefetch from memory into the L2 cache. In this regard, the prefetch logic 310 is configured to execute an algorithm for assessing whether target data external to the cache memory will be requested by the cache memory in the near future. As will be appreciated by persons skilled in the art, “near future” is a relative assessment based on factors such as cache size, type of cache (e.g., data versus instruction cache), code structure, etc.

In a preferred embodiment, both a bounding box prefetcher 312 and a stream prefetcher 314 are implemented, and the ultimate prefetch assessment is based on a collective combination of the results of these two prefetching algorithms. As indicated above, stream prefetchers are well known, and generally operate based on the detection of a sequence of storage references that reference a contiguous set of cache blocks in a monotonically increasing or decreasing manner. Upon stream detection, a stream prefetcher will begin prefetching data up to a predetermined depth—i.e., a predetermined number of cache blocks ahead of the data which the processing system is currently loading. Consistent with the scope and spirit of the invention, different prefetching algorithms may be utilized. Although not specifically illustrated, a learning module may also be included in connection with the prefetcher and operates to modify the prefetching algorithm based on observed performance.

One aspect that is particularly unique to the present invention, relates to the utilization of a confidence measure that is associated with each prefetch request that is generated. The logic or circuitry for implementing this confidence measure is denoted by reference number 320. In this regard, the invention employs a modified version of an LRU replacement scheme. As is known in the art, an LRU array 330 may be utilized in connection with the eviction of data from the least recently used cache line. As mentioned above, the memory area 350 of each L2 cache is 256K. The L2 cache in the preferred embodiment is organized into 16 ways. Specifically, there are 256 sets of 64 byte cache lines, in a 16 way cache. The LRU array 330, therefore, has 16 locations denoted 0 through 15. Each location of the LRU array 330 points to a specific way of the L2 cache. In the illustrated embodiment, these locations are numbered 0 through 15, where location 0 generally points the most recently used way, whereas location 15 generally points to the least recently used way. In the illustrated embodiment, the cache memory is a 16-way set associative memory. Therefore, each location of the LRU array points to one of these 16-ways, and thus each location of the LRU array is a 4-bit value.

Control logic 270 includes the circuitry configured to manage the contents of the LRU array. Likewise, conventional cache management logic (e.g., logic that controls the introduction and eviction of data from a cache) is embodied in the data replacement logic 360. Data replacement logic 360, in addition to implementing conventional management operations of the cache memory area 350, also manages the contents of the cache memory area 350 in conjunction to the novel management operation of the control logic and LRU array 330, to implement the inventive features described herein.

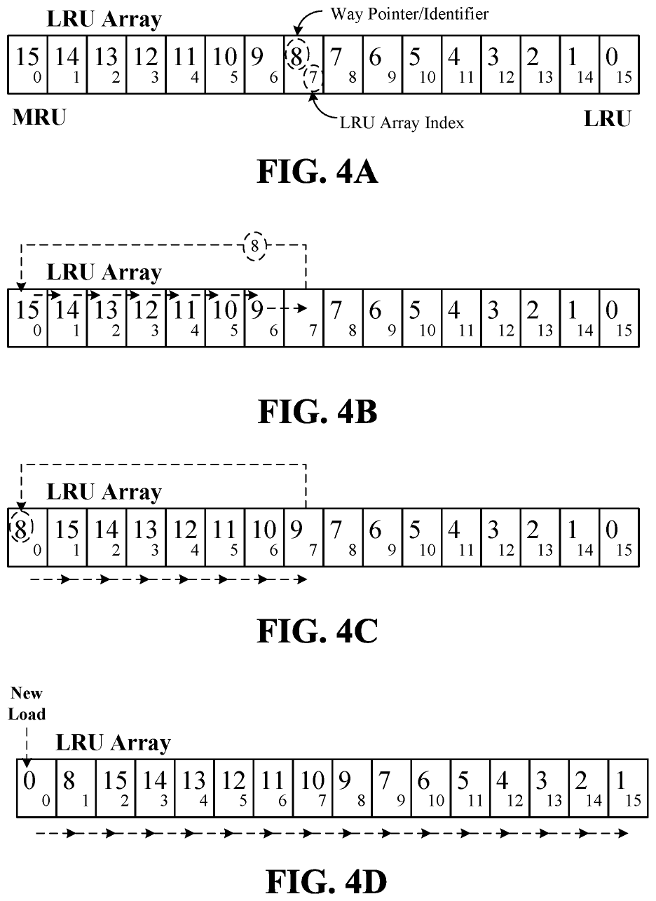

Again, as will be understood by persons skilled in the art, the LRU array 330 is organized as a shift queue. With reference FIGS. 4A through 4D, the following example operation will be described, to illustrate the conventional operation of an LRU array. FIG. 4A illustrates one set of an LRU array having sixteen locations, numbered 0 through 15. As described above, each location of the LRU array points to or identifies a particular way in the cache memory in which target data resides. The nomenclature used in the illustrations of FIGS. 4A-4D is presented such that the smaller number in the lower right hand portion of each cell designates the location identifier within the LRU array, wherein numeral 0 designates the MRU (most recently used) location, while number 15 designates the LRU location. The larger numbers presented in the upper left hand portion of each cell denotes a way within the cache memory. Since, in the illustrated embodiment, the cache memory is a 16 way set associative cache, and the LRU array is a 16 location array, both the array location and the way identifier are 4-bit values. Therefore, each cell location within the LRU array will contain an identifier to each of the sixteen unique ways within the cache memory. It will be appreciated, however, that a different set associativity of the cache may be implemented, which would result in a correspondingly different LRU array size.

As will be appreciated, upon startup, the contents of the array will be in a designated or default original state. As new data is accessed through, for example, core loads, data will be moved into the cache. As data is moved into the cache, with each such load the LRU array will be updated. For purposes of this example, FIG. 4A illustrates what the LRU array may look like at initial start-up. Specifically, in this illustration, it is assumed that the illustrated set of the LRU array sequentially identifies the various cache memory area ways. That is, upon initial start-up, the a given set of the LRU array would appear as shown in FIG. 4A, wherein the 15th location of the LRU array (the LRU location) would point to the 0th way in the cache memory, while the 0th location of the LRU array (the MRU location) would point to the 15th way within the cache memory.

Now suppose, in keeping with a hypothetical example, the core requests data that is determined to exist in the 8th way of the cache. In response to such a load, the LRU array would be updated to relocate the location of the 8th way from the 7th LRU array location to the 0th LRU array location (as it would have become the most recently used). The contents, or pointers, of the 0th LRU location through the 6th LRU location would be shifted to the 1st LRU location through the 7th LRU array location, respectively. These operations are illustrated in FIGS. 4B and 4C, collectively. Since the requested data is already within the cache, an eviction operation need not be performed, but the requested data would be moved to the most recently used cell position in the LRU array.

Now suppose the next data access is a new load to data not currently within the cache. At this time, the oldest data (the data pointed to by the LRU location) would be evicted from the cache, and the new data read into that evicted cache line. As illustrated in FIG. 4C, the 15th location of the LRU array points to the 0th way of the cache. Therefore, the new load data would be read into the 0th way of the cache. The LRU array would then be updated to shift the contents of LRU array locations 0 through 14 to the 1st through 15th locations, and the 0th location would be updated to point to the 0th way of the cache (the way now containing the new data).

Again, the examples illustrated in FIGS. 4A through 4D are conventional and therefore need not be described further herein. They are presented herein, however, to better illustrate the changes and advancements realized by the present invention. In this regard, the present invention modifies this traditional approach to the LRU array management. Specifically, rather than every

load request being assigned to the most recently used position of the LRU array (i.e., LRU location 0), load requests are directly written into specific locations, including intermediate locations (or even the last location), of the LRU array 330, based upon a confidence value associated with the given load request. One mechanism for generating confidence values will be described below. However, by way of example, consider a load request to data that is deemed to have a mid-level confidence value. Rather than the way location of that data being assigned to the LRU array 0 location, it may be assigned to the LRU array 7 location (e.g. near the center of the LRU array). As a result, this data would generally be evicted from the cache before data that was previously loaded, and pointed to by the LRU locations 1 through 6.

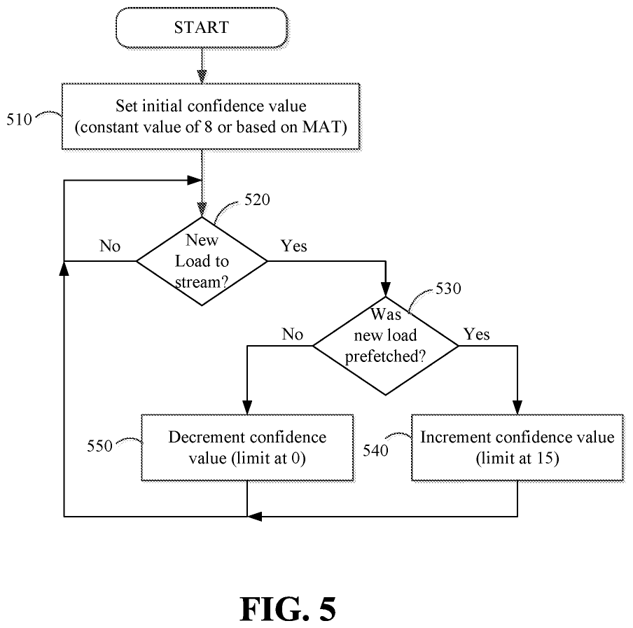

Reference is now made to FIG. 5, which is a flow chart showing a preferred method for generating a confidence value that is used in connection with the present invention. At step 510, the system sets an initial confidence value. In one embodiment, this initial confidence value is set at 8, which is a mid-level (or neutral) confidence value. Consistent with the scope and spirit of the present invention, other initial confidence values may be set as the initial value. Indeed, in another embodiment, the initial confidence value may be based on the memory access type. For additional information regarding MATs, reference is made to U.S. Pat. No. 9,910,785, which is incorporated herein by reference.

Upon receiving a new load request from the core, the system determines whether that load is a new load to the stream (step 520). If so, the system then checks whether that new load had been prefetched (step 530). If so, then the confidence value is incremented by one (step 540). In the preferred embodiment, the confidence value saturates at 15. Therefore, if the confidence value going into step 540 was at a 15, then the confidence value simply remains at 15. If, however, step 530 determines that the new load was not prefetched, then the confidence value is decremented by one (step 550). In this step, the lower limit of the confidence value is 0. Thus, if the confidence value was 0 going into step 550, it would simply remain at 0. Consistent with the scope and spirit of the invention, other algorithms may be utilized to generate a confidence value, and the above-described algorithm is merely one illustration.

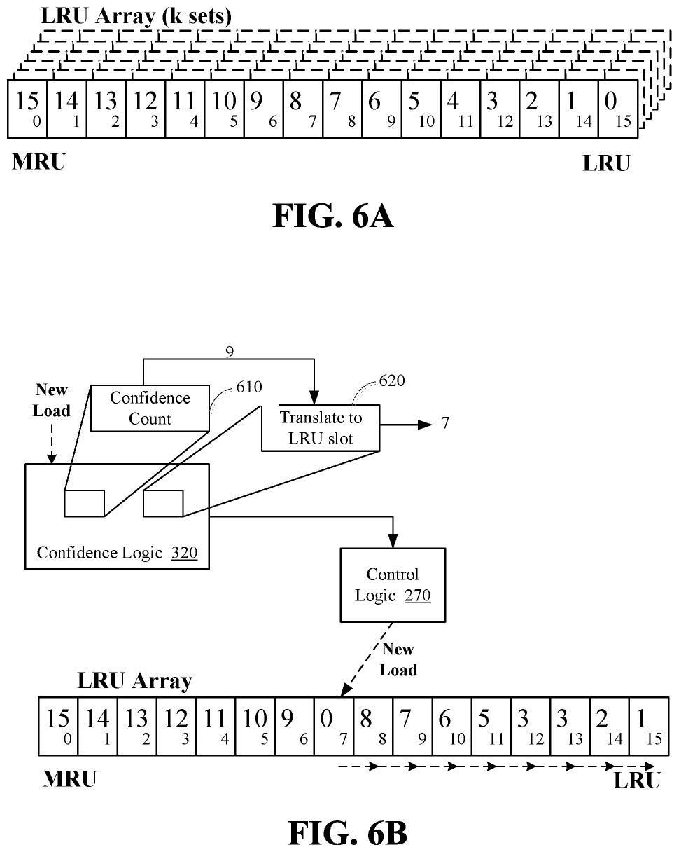

Reference is now made to 6A and 6B, which illustrate how this confidence value is used in the context of the present invention. FIG. 6A presents a hypothetical state of one set of an array, generally organized as an LRU array, which is identical to the state presented in FIG. 4A. As will be understood by persons skilled in the art, the LRU array is organized into a plurality of sets, with each set containing a plurality of locations. In turn, each of the plurality of locations specifies a unique “way” in the set. As illustrated in FIG. 6A, a k-set, n-way associative cache would have k sets, each having a plurality of n (n-ways) cell locations: one cell location for each way. Since the array management of the invention operates the same for each queue, only one of the LRU array sets will be discussed. This set may sometimes be summarily referred to herein as the LRU array, but any such reference will be understood to apply to one set of the LRU array.

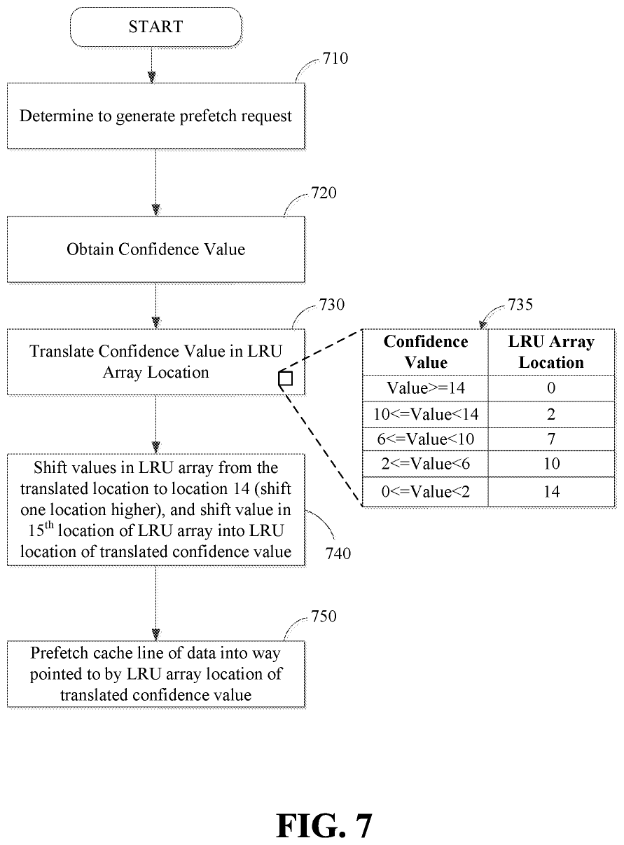

Now it is assumed that, in response to a new load request, data is to be fetched into the cache, which has an assigned confidence value (in this example, a confidence count) of 9. Through a procedure that will be described in connection with FIG. 7, a translation operation is performed on that numerical confidence count to translate that count into a numerical value that corresponds to a specific one of the LRU array locations. As will be described in connection with FIG. 7, a confidence count of 9 translates to LRU location 7. In a conventional implementation of an LRU array, any new load would be assigned to the 0th LRU array location. However, through the utilization of the confidence count of the present invention, the new load of the above hypothetical example would be inserted into the 7th location of the LRU array set. If the way pointed to by the 15th array location of this set (in this example, way 0) contains valid data, the valid data must be evicted from the cache. The LRU array is updated to shift the contents for values in LRU array locations 7 through 14 into LRU array locations 8 through 15 respectively. The way previously pointed to by array location 15 is now moved to the 7th LRU location, and it is within that way that the new data is written.

The control logic 270 and data replacement logic 360, previously described in connection with FIG. 3, are designed to control the management of the information within the LRU array and the memory area 350. Illustrated in FIG. 6B are confidence count logic 610 and translation logic 620, which embody circuitry configured to generate the confidence count (as described in FIG. 5) can translate that confidence count into an LRU array location (as will be described next in connection with FIG. 7).

Finally, reference is made to FIG. 7, which is a flow chart illustrating basic operations of a data fetch and cache LRU array update, in accordance with an embodiment of the present invention. First, there is a high level determination made by the prefetcher to generate a prefetch request (step 710). Thereafter, a confidence value is obtained (step 720). Generally, this value is simply retrieved, as it has been computed in accordance with the operation described in connected with FIG. 5. Thereafter, the confidence value is translated into an LRU array location (step 730). In one embodiment, this translation could be a direct, linear translation between the confidence count and the LRU array location. Specifically, as described in connection with FIG. 5, the confidence value is a numerical value that ranges from 0 to 15. Therefore, this confidence value could be used to directly assign the new load into an LRU array location 15 to 0. Since a confidence value of 15 represents the highest confidence, then the corresponding data would be written into the cache and would be pointed to by LRU array location 0, since that is the most recently used location, and would be appropriate for a data fetch of highest confidence.

However, in a preferred embodiment for the present invention, a nonlinear translation of the confidence value to LRU array location has been implemented. Further, the preferred embodiment of the invention designates five graduations of confidence. That is, there are five specific locations within the LRU array that may be assigned to a new load. As illustrated in the breakout table 735 of FIG. 7 (associated with step 730), the translation is performed such that if the confidence value is greater than or equal to 14, then the LRU array location is translated to location 0. A confidence value that is greater than or equal to 10 but less than 14 is translated into LRU array location 2. A confidence value greater than or equal to 6 but less than 10 is translated into LRU array location 7 (and this is consistent with the example presented in connection with FIG. 6B). A confidence value greater than or equal to 2 but less than 6 is translated into LRU array location 10, and a confidence value greater than or equal to 0 but less than 2 is translated into LRU array location 14.

Once the translation is performed and the LRU array location determined, then appropriate data is evicted from the LRU array and appropriate values in the LRU array locations are shifted one location. Specifically, the values in the translated location through location 14 are shifted one location (step 740). The way previously pointed to by LRU array location 15 is written into the location identified by the translated confidence value. Finally, a cache line of data is prefetched into the way pointed to by the LRU location of the translated confidence value.

In view of the foregoing discussion, it will be appreciated that the invention improves cache performance. Specifically, by inserting prefetched lines with moderate to low confidence values, into the LRU array at a location closer to the LRU array location, avoids premature discarding of MRU cache lines more likely to be used again (and thus avoids have to re-prefetch those lines). Utilization of a prefetch confidence measure in this way reduces the number of “good” cache lines dropped from the cache, and increase the number of good cache lines preserved.

Each array described above have been characterized as being “generally” organized in the form of an LRU array. In this regard, a conventional (or true) LRU array arrangement is modified by the present invention by permitting the insertion of cache memory way of newly-loaded data into an interim cell location of the “LRU array”, instead of the MRU cell position, based on a confidence measure. Further, as will be described below, this same feature of the invention may be implemented in what is referred to herein as a pseudo LRU array.

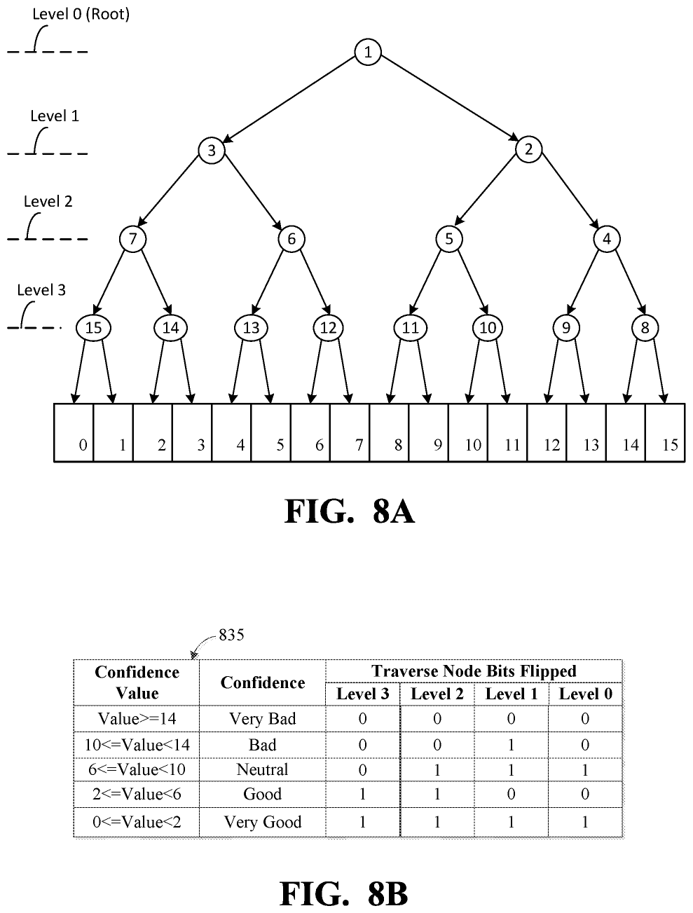

In one implementation, a pseudo LRU (or pLRU) array uses fewer bits to identify the cell locations with the array. As described above, in a “true” LRU array, each cell location of a 16-way LRU array would be identified by a 4-bit value, for a total of 64 bits. In order to reduce this number of bits, a pseudo LRU implementation may be utilized (trading pure LRU organization for simplicity and efficiency in implementation). One such implementation is illustrated with reference to the binary tree of FIG. 8A. As illustrated, a 16-way array implementation can be implemented using 15 bits per set, rather than 64 bits per set, where one bit is allocated for each node of the binary tree. In FIG. 8A, the nodes are numbered 0 through 15 for reference herein, and each node has a single bit value (either a 0 or a 1).

The binary tree of FIG. 8A can be traversed by assessing the bit value of each node. In one implementation, a node value of 0 indicates to traverse that node to the left, while a node value of 1 indicates to traverse that node to the right. Upon start-up, all bits may be reset to zero, and cell location 0 (i.e., way 0) would be the next location of the way to be updated. The location is reached simply by traversing the tree based on the bit value of each node. Specifically, the initial value of 0 in node 1 indicates to go left, to node 3. The initial value of 0 in node 3 indicates to go left to node 7. Likewise, the initial value of 0 in node 7 indicates to go left to node 15. Finally, the initial value of 0 in node 15 means to go left, which identifies the way 0 of the set array. Thereafter, the 15 bit value of defining the values of the nodes in the binary tree is updated to flip each bit value traversed. Thus, the bit values for nodes 1, 3, 7, and 15 would be updated to 1. Assuming the initial fifteen bit value [node 15:node 1] is 000000000000000, after flipping the bit values for nodes 1, 3, 7, and 15, the value would be 100000001000101.

In continuing this example, the next data load would traverse the tree as follows. Node 1, being a 1, would indicate to traverse right. Nodes 2, 5, and 11 (all being their initial value of 0) would all be traversed to the left, and way 8 would be identified as the pLRU way. This way now becomes the MRU way, and the bit values of nodes 1, 2, 5, and 11 are all flipped, whereby node 1 is again flipped to 0, and nodes 2, 5, and 11 are flipped to be values of 1. Thus, the fifteen bit value representing the node values would be: 100010001010110. The next load would then traverse the binary tree as follows. Node 1 is a 0, and is traversed to the left. Node 3 is a 1, and is traversed to the right. Nodes 6 and 13 are still in their initial values of 0 and are traversed to the left, and the cell number 4 would be updated with the way of the loaded value. This way (way 4) now becomes the MRU way. This process is repeated for ensuing data loads.

In accordance with an embodiment of the invention, such a binary tree may be utilized to implement a pseudo LRU algorithm, updated based on confidence values. That is, rather than flipping every bit of the binary tree that is traversed, only certain bits are flipped, based on the confidence value. FIG. 8B is a table 835 that illustrates bits that may be flipped in accordance with on implementation of the invention. FIG. 7 illustrated a table 735 showing how a computed confidence value can be translated into an array location of an LRU array. The table 835 illustrates how the same confidence values may be translated into flipped bits in a binary tree used to implement a pseudo LRU implementation. It should be understood that these are exemplary values, and the different values may be assigned, consistent with the invention, based on design objectives.

To illustrate, and again with reference to the binary tree of FIG. 8A. Upon initial start-up, all bit positions of the nodes are a value of 0, making cell location 0 the LRU position. A first load value is written into the way of that location. Nodes 1, 3, 7, and 15 are traversed to the left to reach that location. If the newly-loaded data has a very low confidence value, then none of the bits of the traversed nodes are flipped. As a result, the next data load will be written into the same way. If, however, the newly loaded data is deemed to have a neutral confidence value, then according to the table 835, the traversed nodes of level 3, 2, and 1 are flipped. Thus, nodes 3, 7, and 15 are flipped from 0 to 1. Therefore, the next load will traverse node 1 to the left, node 3 to the right, and nodes 6 and 13 to the left (and written into way 4). In continuing with the example, assuming that next load is determined to have a confidence value of 11, corresponding to “Bad”, only the traverse node of level 2 (node 6) will have its bit value flipped. As a result, the next load will traverse node 1 to the left, nodes 3 and 6 to the right, and node 12 to the left (and written into way 6).

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims.

Note that various combinations of the disclosed embodiments may be used, and hence reference to an embodiment or one embodiment is not meant to exclude features from that embodiment from use with features from other embodiments. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measures cannot be used to advantage. A computer program may be stored/distributed on a suitable medium, such as an optical medium or solid-state medium supplied together with or as part of other hardware, but may also be distributed in other forms. Note that memory used to store instructions (e.g., application software) in one or more of the devices of the environment may be referred to also as a non-transitory computer-readable medium. Any reference signs in the claims should be not construed as limiting the scope.

At least the following is claimed:

1. A cache memory comprising:
a memory area for storing data requested by the cache memory, the memory area being configured with n-way set associativity;
prefetch logic configured to execute an algorithm for assessing whether target data external to the cache memory will be requested by the cache memory in the near future;
a array of storage locations generally organized in the form of k (where k is an integer value greater than 1) one-dimensional arrays, each of the k arrays having n locations, wherein each such array location identifies a unique one of the n-ways of the memory area for a given one of the k arrays, and wherein each array is organized such that a sequential order of the plurality of array locations generally identifies the n-ways in the order that they are to be replaced;
further comprising, for each of the plurality of one-dimensional arrays:
confidence logic associated with the prefetch logic configured to compute a confidence measure, which confidence measure reflects a determined likelihood that the target data will be requested by an associated processor in the near future; and
control logic configured to manage the contents of data in each array location, the control logic being further configured to:
assign a particular one the array locations to correspond to the way where the target data is to be stored, based on the computed confidence measure;
shift a value in each array location, from the assigned array location toward an array location corresponding to a position for next replacement; and
write a value previously held in the array location corresponding to a next replacement position into the assigned array location.

2. The cache memory circuit of claim 1, wherein each one-dimensional array is generally organized as either a modified least recently used (LRU) array or a modified pseudo LRU array, wherein a conventional LRU arrangement is modified by allowing out-of-order insertions in the array based on the confidence measure.

3. The cache memory circuit of claim 1, wherein the cache memory is a level 2 cache memory.

4. The cache memory circuit of claim 1, where the algorithm includes at least one of a bounding box prefetch algorithm or stream prefetch algorithm.

5. The cache memory circuit of claim 1, wherein the confidence logic includes logic modify the confidence measure in response to each new load request, such that the confidence measure is incremented if the new load was prefetched and the confidence measure is decremented if the new load was not prefetched.

6. The cache memory circuit of claim 5, further including logic for translating the confidence measure into a numerical value that serves as an index for one of the n-array locations of the prefetch memory array.

6. The cache memory circuit of claim 6, wherein the translation of the confidence measure into the numerical value is a non-linear translation.

8. The cache memory circuit of claim 1, further including logic for translating the confidence measure into a numerical value that serves as an index for one of the n-array locations of the prefetch memory array.

9. An n-way set associative cache memory comprising:
prefetch logic configured to execute an algorithm for assessing whether target data external to the cache memory will be requested by the cache memory in the near future;
a k-set array, each of the k sets having n array locations, wherein each of the n array locations identifies a unique one of the n-ways of a given set of the cache memory;
confidence logic configured to compute a confidence measure that reflects a determined likelihood that the target data will be requested by an associated processor in the near future; and
control logic configured to adjust the values in a select one of the k sets by writing a value from the array location corresponding to a least recently used (LRU) position to an intermediate location in the selected set, based on confidence measure, and shifting values in each array location from that intermediate storage toward the penultimate LRU position by one location.

10. The n-way set associative cache memory of claim 9, wherein each of the k arrays is generally organized as either a modified least recently used (LRU) array or a modified pseudo LRU array, wherein a conventional LRU arrangement is modified by allowing out-of-order insertions in the array based on the confidence measure.

11. The n-way set associative cache memory defined in claim 9, wherein the control logic is particularly configured to:
assign a particular one the array locations to correspond to the way where the target data is to be stored, based on the computed confidence measure;
shift by one location, a value in each array location, from the assigned array location to an array location corresponding to an LRU position; and
write a value previously held in the array location corresponding to the LRU position into the assigned array location.

12. The n-way set associative cache memory defined in claim 10, where the algorithm includes at least one of a bounding box prefetch algorithm or stream prefetch algorithm.

13. The cache memory circuit of claim 10, wherein the confidence logic includes logic modify the confidence measure in response to each new load request, such that the confidence measure is incremented if the new load was prefetched and the confidence measure is decremented if the new load was not prefetched.

14. The cache memory circuit of claim 13, further including logic for translating the confidence measure into a numerical value that serves as an index for one of the n-array locations of the LRU array.

15. A method implemented in an n-way set associative cache memory, the method comprising:
determining to generate a prefetch request;
obtaining a confidence value for target data associated with the prefetch request;
writing the target data into a set of the n-way set associative cache memory;
modifying an n-position array of the cache memory, such that a particular one of n array positions identifies one of the n ways, wherein the particular one of the n LRU array positions is determined by the confidence value.

16. The method of claim 15, wherein the modify step more specifically comprises:
assigning a particular one the LRU array positions to correspond to one of the n ways where the target data is written, based on the confidence value;
shifting by one location, a value in each array position, from the assigned array position toward an array position corresponding to an LRU position; and
writing a value previously held in the array position corresponding to the LRU position into the assigned array position.

17. The method of claim 15, where the determining step includes implementing at least one of a bounding box prefetch algorithm or stream prefetch algorithm.

18. The method of claim 15, wherein obtaining a confidence value includes computing the confidence measure, which confidence measure reflects a determined likelihood that the target data will be requested by an associated processor in the near future.

19. The method of claim 15, wherein the confidence value is modified in response to each new load request, such that the confidence value is incremented if the new load was prefetched and the confidence measure is decremented if the new load was not prefetched.

20. The method of claim 15, wherein each of the k arrays is generally organized as either a modified least recently used (LRU) array or a pseudo modified LRU array, wherein a conventional LRU arrangement is modified by allowing out-of-order insertions in the array based on the confidence measure.
